(19) United States
(12) Patent Application Publication
(10) Pub. No.: US 2021/0210995 A1
(43) Pub. Date: Jul. 8, 2021

(54) PERMANENT MAGNET MOTOR

(71) Applicant: BINZHOU UNIVERSITY, Binzhou, Shandong (CN)

(72) Inventor: Lianxue GAO, Binzhou (CN)

(73) Assignee: BINZHOU UNIVERSITY, Binzhou, Shandong (CN)

(21) Appl. No.: 17/055,712

(22) PCT Filed: May 13, 2019
(86) PCT No.: PCT/CN2019/086696

§ 371 Date: Nov. 16, 2020

(30) Foreign Application Priority Data
May 14, 2018 (CN) 201811548314.X

(51) Int. Cl. H02K 1/02; H02K 1/27; H02K 3/28; H01F 1/057

(52) U.S. Cl. CPC H02K 1/02; H02K 1/276; H02K 2213/03; H01F 1/0577; H02K 3/28

(57) ABSTRACT

A permanent magnet motor including a stator, a rotor and a control circuit. The control circuit is the closed-loop control circuit, including a speed control device, a torque control device, a voltage vector control device, a space vector control device, and an inverter control device connected in sequence. A stator magnetic circuit includes a magnetic linkage correction circuit, the magnetic linkage correction circuit is composed by a single integrator and a low-pass filter connected in series; Small leakage, small magnetic chain harmonic of permanent magnet, small eddy current loss and iron loss of motor, good control accuracy, no shaking of motor rotor and a long service life can obtained.

This application claims the benefit of Chinese Patent Application NO.201811548314X, entitled: “PERMANENT MAGNET MOTOR”, filed on May 14, 2018, in Chinese Patent Office, the disclosure of which is incorporated herein by reference in its entirety.

### FIELD

The invention relates to a permanent magnet motor, a permanent magnet control motor made of high strength permanent magnet material, especially a permanent magnet control motor used in special engineering vehicles, etc.

### BACKGROUND

Rare earth permanent magnetic materials have become an irreplaceable basic material in many fields, and are widely used in generators, motors, computers, automobiles, military industry, medical facilities, power tools, office equipments, household appliances and other fields, driving the development of various industries.

In prior art, it is very common to use high performance rare earth permanent magnetic materials and their preparation methods, motors and generators made of the materials, and uses of generators and motors in automobiles, military industry, medical facilities, power tools, household appliances and other fields. In the existing patent, a preparation method of rare earth permanent magnet materials is described, in which a method of hot pressing and thermal deformation is a preparation method of permanent magnet materials with high dimensional accuracy and high performance, and the main preparation processes include the preparation of permanent magnet powder, forming a hot pressing magnet pressed under a certain temperature, and forming the thermal deformation magnet powder by thermal deformation of the hot pressing magnet. In the whole process, it needs very high requirements of the permanent magnet powder, the thermal pressing deformation technology, etc. Any one different step or temperature change is likely to be crucial influence on the performance of the final product, and may lead to defects such as great changes on magnetic performance and uneven magnetic field. When used in motor, because of the uneven magnetic field, problems may occur in the motor, such as large vibration, high noise and abnormal operation, and so on. At the same time, it can not meet the requirements of reduced motor magnetic performance under high temperature and long-term operation.

Chinese Patent CN104143402A discloses a material for thermal deformation magnet based on the composition of PrGaBFe, which provides many improved methods to improve the remanence and coercive force of the magnet, have the original molecular orientation of more than 0.92, and further improve the performance of the final magnet. But it is still unable to strictly control in magnetic field uniformity, etc, and cannot produce large number of productions. Chinese Patent CN104043834A proposes to mix NdFeB material powder with powder containing Tb and Dy, and to apply hot pressing and thermal deformation to the mixed powder. CN102496437A proposes a method for preparing anisotropic nanocomposite magnets, in which the volume percentage of soft magnetic phase is 2-40% to further improve the remanence and magnetic energy product of permanent magnet materials. Chinese Patent document CN104078179A discloses a method for preparing thermal deformed magnets, in which NdFeB material powder is used to perform precipitation treatment of heavy rare earth elements RH to adhere heavy rare earth elements onto the powder surface, so as to improve the coercive force of final magnets and reduce the amount of heavy rare earth. The permanent magnet generated by thermal deformation is likely to still lose its magnetism under high temperature, and it cannot solve the problem of magnetic uniformity, and the possibility of generating uniform magnetic field in the motor, resulting in the low performance of the generator and motor.

In generators and motors, permanent magnets made of permanent magnetic materials with good heat resistance are needed, the so-called heat resistance of permanent magnets refers to the fact that their magnetic properties do not deteriorate due to temperature rise. In early 1990s, researchers in Japan and the United States developed Nd—Fe—B alloy respectively, and used the method of rapid quenching to prepare commercial magnetic powder, which became the third generation of rare earth permanent magnet materials. The heat resistance of this material cannot be fully applied to motors for a long time. The use of Nd—Fe—B magnets on the equipment close to the heating source of the machine requires that the magnetic properties do not deteriorate with the used temperature rise, that is, the remanence Br does not deteriorate. Usually sintered Nd—Fe—B magnets cannot be used near the occasion in the temperature up to 200° C., the Curie temperature is only about 320° C., and the temperature coefficient is large. With the continuous expansion of the application range of rare earth magnets, such as automotive starting motors, motor products and integrated CO-ROM for the expansion of the demand range of sintered Nd—Fe—B, the performance of magnets under high temperature in the current miniaturization equipment has been put forward higher requirements.

In the prior art, it is found that processes of addition and grain refinement for a small amount of Nd-enriched grain boundary and a small amount of Tb and Dy can effectively improve the permanent magnet performance Up to now, Nd—Fe—B is still one of the best permanent magnetic materials, but it is still not good to achieve that the rare earth powder is mixed with the nano-crystalline Nd—Fe—B magnetic powder, and is applied by hot pressing and thermal deformation, and the rare earth powder is applied to Nd—Fe—B magnetic powder by grain boundary diffusion to obtain high coercive force, and the cost is relatively high. Cerium-based permanent magnet with Nd₂Fe₁₄B crystal structure is also prepared, but the early research results are not ideal. In Chinese Patent CN102779602A, the United States GM Global Technology Operations LLC, LTD is successfully developed with commercial applications of cerium base permanent magnet materials in 2014, in which the total value sum of intrinsic coercive force H_{ci} (in terms of kOe) and remanence Bᵣ (in terms of kG) is 9 or higher, the value of maximum magnetic energy product (BH)ₘₐₓ (in terms of MGOe) reaches 4.59.

In the use of rare earth materials, it has been disclosed that La partially replacing Nd₂Fe₁₄B's Nd or itself is prepared for permanent magnetic materials as rare earth materials (Appl. Phys. Lett. 47,757),which is still in a basic research stage. However, no material with commercial application value has been obtained until now when the patents about Cer-based permanent magnet have been disclosed. The resulting La₂Fe₁₄B has a saturation magnetization intensity of 4 π Mₛ and Curie temperature T_{c} higher than that of Ce₂Fe₁₄B, but its anisotropic field Hₐ is lower than that of Ce₂Fe₁₄B. What's more, the synthesis of La₂Fe₁₄B is very difficult and cannot be used in generators and motors.

Chinese Patent CN1557004A have been recorded that a permanent magnet contains more than one or two of rare earth elements but no disclosure of specific manufacturing process. In the technical solution, Zr element is added, and it relates to the field of sintering rare earth permanent magnet. Because of no good enough performance and defects in remanence, coercive force, magnetic performance and higher price, etc, it is not still seen that the related material has been used in generators and motors. There is also no related technology in the motor to improve the magnetic material as part of the motor rotor to complete the normal operation of the motor. Therefore, it is necessary to provide specific cooling and effective control of the motor, such as reducing the load, overcurrent protection and other ways to achieve that the motor temperature does not reach the predetermined temperature so as to achieve magnetic stability.

In motors, it is common that changes of magnetic performance of permanent magnet material due to high temperature affect the performance of the motors, especially in linear motors, permanent magnet synchronous motors, it can lead to low efficiency, large noise, large thrust fluctuation, and serious impact torque stability. Therefore, it is necessary to improve the structure of motor and the control circuit in motors so as to overcome the influence of heat generated with high power output in a long term in motor operation on the magnetic performance of permanent magnet material, which will cause unstable changes in motor performance, and even the excitation-loss phenomenon impacting greatly on motors and generators.

In particular, subtle changes of motor structure in permanent magnet motors provide different flux path, which can affect the change of the magnetic flux, produce more magnetic loss. Especially, under long term operation in full load or locked rotor of motor, the magnet structure change of permanent magnet due to the high temperature may cause magnetic loss or changes of residual magnetic pole strength and so on, so that the phenomenon such as operation instability, or vibration, or noise in the motor can occur.

In the control of permanent magnet control motor, since the established control mode is mostly fixed, this design is easy to cause the motor control modelling, and cannot adapt to the motor performance changes caused by the magnetic changes so that it is easy to cause over control or under control in the load. Similarly, in the design of the multi-phase fault-tolerant permanent magnet control motor in the prior art, the fractional slot concentrated winding is adopted, the harmonic number decreases, but the amplitude value increases, resulting in the large iron loss of the motor. The performance of permanent magnet control motor can not be improved while the fault tolerance of permanent magnet control motor can not be satisfied.

Existing multiphase permanent magnet motor control PWM algorithm, although the matrix transformation is proposed to adapt to the magnetism changing of the permanent magnets in the motor, the magnetism under different temperatures and problems of load and current in operation is still unable to realize real-time tracking and realize changes in the range of the linear modulation and over modulation. During selecting the pulse width modulation, technical indicators of the output voltage harmonic content, digital implementation complexity, bus voltage utilization, and so on are considered comprehensively. In this way, effects of the leakage inductance of the permanent magnet motor control, permanent magnet magnetic chain harmonic are ignored. Therefore, the large current fluctuations have an impact on the service life of the permanent magnet control motor control devices, and cause the permanent magnet control motor operation instability.

In the current vector control of motor, due to the speed closed-loop system design, it is difficult to track the inertia lag link, and the multiple harmonics in the permanent magnet magnetic chain lead to a large harmonic component in the phase current, loss changes in the vector control is difficult to control, and torque instability and other problems may occur. Especially in the large truck in bad construction conditions, there is large change of temperature difference, full load operation, dust, moisture and other extreme weather conditions, because the magnet steel eddy current loss and harmonic loss cause problems such as the rotor excessive heat, temperature increase, in practice, the actual phenomenon can rise to nearly 130 degrees, in order to guarantee the continuity of construction, it is usually needed to carry the stable operation of motor, permanent magnet motors because of affected by the above conditions often cannot meet the needs of engineering, and this application is to solve the above problems to provide such as engineering vehicles with the permanent magnet control motor with stable operation and long service life.

### SUMMARY

The aim of the present invention is to overcome the shortage in the prior art, and to provide a permanent magnetic material and its preparation method used in permanent magnet control motors, and a motor with the corresponding specific structure and its control circuit. By the whole design comprehensive solution to the above a series of problems, of course, one of the design can solve problems existing in permanent magnets, motors, and control circuits, etc. The high residual magnetic polarization intensity, high density and high magnetic energy product can be obtained. It is simple in preparation process and easy to operate, and can effectively improve the mechanical performance of the permanent magnet control motor, at the same time, relatively good thermal conductivity reduces the rotor temperature and extends the service life of the permanent magnet control motor; The motor has a small leakage inductance, permanent magnet magnetic chain harmonic, small eddy current loss and the iron loss of motor, can be adapted to the control of the motor, to complete a good control, to adapt to the adverse effect on magnetism due to temperature change and load change, can quickly complete the corresponding instructions with permanent magnet motor control fluid, motor rotor no shaking.

A permanent magnet control motor made of a high-strength permanent magnet material, including a stator, a rotor and a control circuit, is characterized in that the control circuit is a closed-loop control circuit, including a speed control device, a torque control device, a voltage vector control device, a space vector control device and an inverter control device connected in sequence.

The current/voltage transformation value obtained from the inverter control device is provided to the stator flux control device, and different control signals generated by the stator flux control device are transmitted to the speed control device, the torque control device and the voltage vector control device respectively. The position signal is obtained according to the rotation angle detected by the position sensor of the permanent magnet control motor and is transmitted to the speed controller to generate angular velocity. Wherein, the stator magnetic circuit contains a magnetic link correction circuit, which is composed of an integrator in series with a low-pass filter.

It is characterized in that the three-phase current and three-phase voltage are obtained by an analog-to-digital converter in the stator flux linkage control device.

It is characterized in that the rotor comprises a first permanent magnet and a third permanent magnet arranged below the first permanent magnet, which are made of magnets of different materials and are not in direct contact with each other.

It is characterized in that the stator uses three water cooled control, in which a water cooled first channel, a water cooled second channel, and a water cooled third channel are provided from the inside to the outside, in turn, coils of the stator inner winding and the stator outer winding are provided respectively between the water cooled first channel and the water cooled second channel, and between the inner winding and the outer winding is provided silicon steel sheets.

It is characterized in that the said first permanent magnet is sintered by a first alloy powder made by grinding alloy melted by a first component and a second alloy powder made by grinding alloy melted by a second component, the first and the second alloy powder are mixed with a weight percentage of 7:3; and the said third permanent magnet is sintered by the said first alloy powder made by grinding alloy melted by the said first component and the said second alloy powder made by grinding alloy melted by the said second component, the first and the second alloy powder are mixed with a weight percentage of 4:6.

Additional aspects and advantages of this disclosure will become apparent in the description section below, or through the practice of this disclosure.

### BRIEF DESCRIPTION OF THE DRAWINGS

The above and/or additional aspects and advantages disclosed herein will become apparent and easy to understand in combination with the description of the embodiments in the attached drawings below, where:

FIG. 1 shows the magnetization curve and the hysteresis loop of the first permanent magnet of the present invention;

FIG. 2 shows the magnetization curve and the hysteresis loop of the third permanent magnet of the present invention;

FIG. 3 shows the schematic diagram of the arrangement of the rotor permanent magnet of the present invention;

FIG. 4 shows the schematic diagram of the arrangement of another rotor permanent magnet of the present invention;

FIG. 5 shows the schematic diagram of the stator core structure of the permanent magnet control motor of the present invention;

FIG. 6 is a simulation diagram of magnetic field intensity in the stator core of the permanent magnet control motor of the present invention;

FIG. 7 shows the schematic diagram of the control circuit of the permanent magnet control motor of the present invention;

FIG. 8 shows the waveform of the pulse width modulation signal within two cycles in one sector;

FIG. 9 shows the relationship between the estimated value and the actual value in the stator flux linkage obtained by simulation;

FIG. 10 shows the calculation formula model diagram of the magnetic path correction circuit.

### DETAILED DESCRIPTION

In order to better understand the above purposes, features and advantages of this disclosure, the following is a further detailed description of this disclosure in combination with the attached drawings and specific embodiments. While each embodiment represents a single combination of the invention, the disclosure of different embodiments may be substituted or combined into, such disclosure may be deemed to contain all possible combinations of the same and/or different embodiments disclosed. Thus, if one embodiment contains A, B, C, and another contains a combination of B and D, this disclosure shall also be deemed to include an embodiment of one or more of all other possible combinations of A, B, C, D, even though the embodiment may not be explicitly documented in the following.

Many specific details are described below in order to fully understand the disclosure, but the disclosure may be implemented in other ways that are different from those described here. Therefore, the protection scope of the disclosure is not limited by the specific embodiments disclosed below.

The invention adopts a core with multi-layer and multi- sintering process, which forms stable magnetic performance and is not affected by the magnetic coercive force in the continuous high-speed operation of the motor. The special design method is especially suitable for the permanent magnet control motor.

In order to meet the requirement of precise control, the present invention first is designed on the choice of permanent magnet, and passed through the experiment and test in the materials research institute. The permanent magnet made by specific local magnetic material selection and process has a increased crystal cell volume, a good performance of compound Curie temperature, a good magnetic coercive force, and a increased significantly magnetic flux of permanent magnet in the same volume compared with that in prior art.

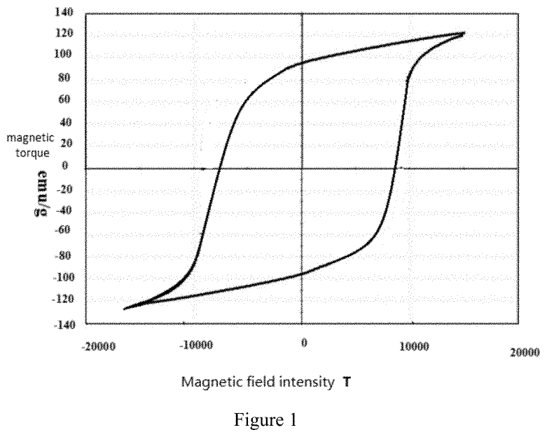

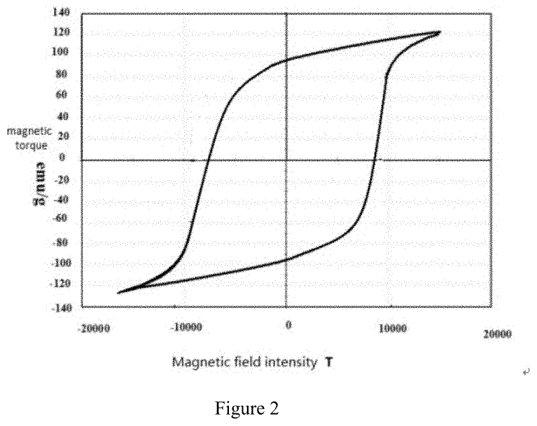

Combining with the embodiments, the present invention is further described in details below in which the shown embodiments are only parts of the data, rather than the limitation on the invention itself, but the innovation of the present invention comes from the influence of the process and formula on the magnetic performance of permanent magnet, especially suitable for control motors with precise control and engineering machines used in extreme weathers. FIG. 1 shows the magnetization curve and hysteresis loop of the first permanent magnet of the present invention. FIG. 2 shows the magnetization curve and hysteresis loop of the third permanent magnet of the present invention.

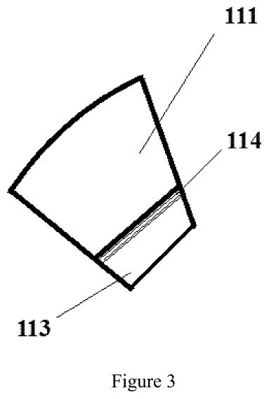

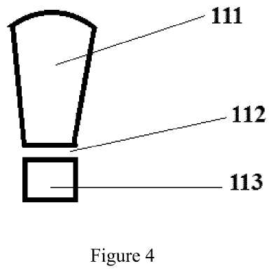

According to the requirements of rotor design in the motor, a permanent magnet can be made in one time, the finished permanent magnet can be directly installed in the rotor of the permanent magnet control motor. The permanent magnet nucleus is prepared according to the shape of the magnet in the manufacturing. The related motor in the present invention is a permanent magnet control motor with long axis, in order to ensure accuracy and production technology, a small rectangle block processing technology is chosen in manufacturing the permanent magnet, and finally, the formed permanent magnet blocks are layered to form a rotor magnet with shape of a approximate bar. FIG. 3 shows an optimal embodiment, in which the filling material 114 with small magnetism are between the first permanent magnet 111 and the third permanent magnet 113. FIG. 4 shows a gap 112 providing between the first permanent magnet 111 and the third permanent magnet 113. By means of the setting gap or the low magnetic filling material between magnets in the magnetic block layer, the present invention can increase the high order harmonic magnetic field reluctance and harmonic leakage reactance, reduce the degree of magnetic linkage of the motor, weaken the harmonic current in the motor, reduce the harmonic loss of the stator and the rotor as well as the surface loss, and thus reduce the temperature rise of the motor.

In preparing the first permanent magnet 111, the materials is mixed in accordance with the weight percentage of the first components and melted at high frequency in the environment of high purity argon, and the first alloy in shape of thin sheet is made by using continuous casting device. The materials is mixed according to the weight percentage of the second components and melted at high frequency in the environment of high purity argon, and the second alloy being slinging strip is formed by pouring and cooling after melted. The first alloy is put into a device for pulverizing by nitrogen stream to obtain the first alloy powder. The second alloy is put to be smashed by hydrogen and pulverized by air flow to obtain the second alloy powder. The first alloy powder and the second alloy powder are mixed in a ratio of 7:3, the resulting mixed powder is orienting pressed in an inert gas environment by adding a magnetic field to the grinding tool of the molding press, and the formed magnet is selected. The formed magnet is continuously heated in a vacuum furnace at 800° C.˜900° C. for 4 hours, and continuously heated in a vacuum furnace at 1100° C. for 2 hours, and then sintered. Then, two-stage tempering is adopted in the vacuum furnace. The first-stage tempering temperature is 800° C. maintained for 2 hours, and the second-stage tempering temperature is 400° C. maintained for 4 hours. After sintering and cooling to room temperature, the body of the magnet is obtained, and the first permanent magnet 111 is obtained after grinding and rapid cutting. In this embodiment, the higher residual flux density of the prepared materials and process is optimized.

The weight percentage of the first component of the first permanent magnet 111 is Nd28.23˜32.73%, Nb1.75˜2.27%, Al3.32˜6.78%, heavy rare earth elements 0.40˜0.67%, and Fe of the residual. Heavy rare earth elements include Er and Lu. In this particular configuration, the resulting permanent magnet has light weight and magnetic stability, which is used in the outer circumference of the rotor of the permanent magnet control motor to ensure smooth start, as well as the pressure of the rotating bearing in high-speed rotation. Wherein, the metal structure of combination of the rare earth and Fe in the permanent magnet after hot melted can be embedded by interstitial atom under a certain temperature, and appropriate element replacement may obtain permanent magnets with improved magnetic performance. When the iron atoms spacing is less than 0.245 nm, negative exchange effects occur among these Fe atoms, the bond length of metal atoms formed by the rare earth and Fe can be adjusted by Nd, Nb, Al, the preferred result is Nd 32.73%, Nb 2.27%, Al 5.72%, 0.40% heavy rare earth elements, and Fe of the residual. The resulting metal compounds can be analyzed by conventional experiments to obtain scattering intensity of the metal atoms and interaction on atoms by X-ray diffraction and interaction with electrons. Similarly, the neutron diffraction method can penetrate the metal, especially the first alloy with thin sheets, to facilitate the distinction between light elements and isotopes, etc. The resulting first alloy has a large volume in crystal cell, magnetic stability and light weight of magnets.

The weight percentage of the second component of the first permanent magnet 111 is: LaCe13.21˜18.33%, Al0.52˜0.71%, rare earth elements 0.40˜0.51%, and FeB of the residual. Rare earth elements include Pr, Nd, etc. In this particular configuration, the bond length of metal atoms formed by the rare earth and FeB can be adjusted by Nd, Nb, Al, the remanence and intrinsic coercive force are greatly improved, the resulting permanent magnet has light weight and large remanence ratio, which is used in the outer circumference of the rotor of the permanent magnet control motor to ensure smooth start, as well as the pressure of the rotating bearing in high-speed rotation. The preferred is LaCe14.31%, Al0.71%, rare earth element 0.44%, and FeB of the residual. The metal grinding powder formed by these components is mixed with the first group of metal grinding powder in a ratio of 2:1, which is easy to be pressed and formed, with good magnetic orientation, compact structure and small clearance. In sintering, finer grain size can be obtained and coercive force can be increased significantly.

The first permanent magnet 111 formed by the above process and component ratio has good thermal stability and light weight, and its magnetic energy product is larger than that of common permanent magnet materials. FIG. 1 shows the magnetization curve and hysteresis loop of the first permanent magnet 111.

The third permanent magnet 113 is prepared from two component materials. The weight percentage of the first component of the third permanent magnet 113 is PrNd 31.11˜35.89%, Gd0.47-0.86%, Al3.32˜7.57%, heavy rare earth elements 0.40˜0.67%, and Fe of the residual. Heavy rare earth elements include Er, Lu, etc. In this particular configuration, the permanent magnet with magnetic stability and high coercive force is used in the deep slot of the rotor of the permanent magnet control motor to ensure good starting torque and the pressure of the rotating bearing in high-speed rotation. The metal structure of combination of the rare earth and Fe in the permanent magnet after hot melted can be embedded by interstitial atom under a certain temperature, and appropriate element replacement may obtain permanent magnets with improved magnetic performance When the iron atoms spacing is less than 0.245 nm, negative exchange effects occur among these Fe atoms, the bond length of metal atoms formed by the rare earth and Fe can be adjusted by Nd, Nb, Al, the preferred result is PrNd 29.73%, Nb 2.27%, Al6.34%, 0.43% heavy rare earth elements, and Fe of the residual. The resulting metal compounds can be analyzed by conventional experiments to obtain scattering intensity of the metal atoms and interaction on atoms by X-ray diffraction and interaction with electrons. Similarly, the neutron diffraction method can penetrate the metal, especially the first alloy with thin sheets, to facilitate the distinction between light elements and isotopes, etc. The resulting first alloy has a large volume in crystal cell, magnetic stability and light weight of magnets.

The weight percentage of the second component of the third permanent magnet 113 is generally the same as that of the second component of the first permanent magnet 111, except that the weight percentage of the second component of the first permanent magnet 111 is significantly increased: LaCe13.21˜18.33%, Al0.52˜0.71%, rare earth elements 0.53˜0.67%, and FeB of the residual. Rare earth elements include Pr, Nd etc. In this particular configuration, the bond length of metal atoms formed by rare earth and FeB can be adjusted by Nd, Nb, Al, the remanence and intrinsic coercive force are greatly improved, the resulting permanent magnet has light weight and large remanence ratio, which is used in the outer circumference of the rotor of the permanent magnet control motor to ensure smooth start, as well as the pressure of the rotating bearing in high-speed rotation. The preferred is LaCe14.31%, Al0.71%, rare earth element 0.44%, and FeB of the residual. The metal grinding powder formed by these components is mixed with the first group of metal grinding powder in a ratio of 4:6, which is easy to be pressed and formed. The sintered and formed permanent magnet can be obtained and used in the deep slot of the motor, its starting torque increases obviously. The permanent magnet in this process is tenacious, easy to process and has good coercive force.

The third permanent magnet 113 is so fabricated. The materials is mixed in accordance with the weight percentage of the first components and melted at high frequency in the environment of high purity argon, and the first alloy in shape of thin sheet is made by using continuous casting device. The materials is mixed according to the weight percentage of the second components and melted at high frequency in the environment of high purity argon, and the second alloy being slinging strip is formed by pouring and cooling after melted. The first alloy is put into a device for pulverizing by nitrogen stream to obtain the first alloy powder. The second alloy is put to be smashed by hydrogen and pulverized by air flow to obtain the second alloy powder. The first alloy powder and the second alloy powder are mixed in a weight ratio of 4:7, the resulting mixed powder is orienting pressed in an inert gas environment by adding a magnetic field to the grinding tool of the molding press, and the formed magnet is selected. The formed magnet is continuously heated in a vacuum furnace at 850° C.˜950° C. for 4 hours, and continuously heated in a vacuum furnace at 1150° C. for 2 hours, and then sintered. Then, tempering is adopted in the vacuum furnace. After sintering and cooling to room temperature, the body of the magnet is obtained, and the third permanent magnet is obtained after grinding and rapid cutting so as to ensure good intrinsic coercive force.

The third permanent magnet 113 formed by the above process and component ratio has good thermal stability and light weight, and its coercive force is larger than that of common permanent magnet materials. FIG. 2 shows the magnetization curve and hysteresis loop of the third permanent magnet 113.

FIG. 3 shows the schematic diagram of the arrangement of the rotor permanent magnet. The radial length ratio of the first permanent magnet 111 and the third permanent magnet 113 is 3:1, and the radial length ratio of the gap 112 and the third permanent magnet 113 is 1:6. By the particular magnet length ratio and clearance ratio, it can ensure increasing significantly the high order harmonic magnetic field reluctance and harmonic leakage reactance in operating, reducing the degree of magnetic linkage of the motor in operating, weakening the harmonic current in the motor, reducing the harmonic loss of the stator and the rotor as well as the surface loss, and reduce the temperature rise of the motor. In addition, it is necessary to ensure the maximum magnetic field intensity of the permanent magnet control motor in starting, improving the starting torque, reducing the starting current of the motor stator, and improving the winding service life of the permanent magnet control motor.

In the preferred embodiment, FIG. 4 shows another schematic diagram of the arrangement of the rotor permanent magnet. The radial length ratio of the first permanent magnet 111 and the third permanent magnet 113 is 3:1, and the radial length ratio of the filling material 114 and the third permanent magnet 113 is 1:9. The filling material 114 is so formed that the first alloy powder and the second alloy powder in the third permanent magnet 113 are mixed in a ratio of 5:5, mixed with silicon grease, and prepared into slurry which is filled between the first permanent magnet 111 and the third permanent magnet 113. The proportion of silica gel volume to the total volume of the slurry shall be no less than 50%. In the preferred embodiment, the ratio of about 73% of the slurry volume is selected. This method can significantly reduce the temperature rise of the permanent magnet control motor, increase the magnetic field intensity in the starting of the permanent magnet control motor, reduce the current impact of the permanent magnet current on the winding, and improve the service life of the permanent magnet control motor.

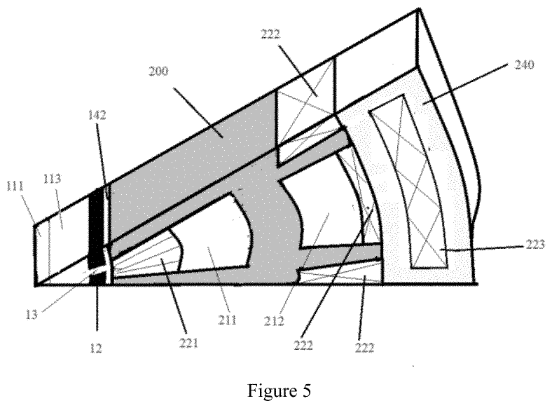

The motor of the present invention is used in large-scale engineering vehicles which are usually in a bad high temperature environment such as a desert, barren hills, etc. In engineering, due to large temperature difference between day and night, as well as the high load in a long-term running to ensure magnetic stability of the permanent magnet, the present invention can obtain good results by magnetic optimization. In the overall motor design of the present invention, higher reliability can be obtained through the cooling environment change and the electronic control. The cooling system of the permanent magnet control motor of the present invention mainly includes a mixture cooling structure of axial fan cooling inside the duct and water cooling in the stator, meets the high power operation demand in engineering of the permanent magnet control motor. In the western desert engineering experiment, it can keep a good performance record without stopping for more than 20 days continuously. FIG. 5 is a schematic diagram of the stator core structure of the permanent magnet control motor in the present invention.

The rotor permanent magnet 11 includes a first permanent magnet 111, a gap 112 and a third permanent magnet 113. The rotor permanent magnet is put in a groove stamped by a magnetic steel 12, and in the middle of the magnetic steel 12 is set an impact slit 13 which can ensure that non-standard permanent magnets are easy to be placed and silicone is filled. In order to ensure the starting torque of the permanent magnet control motor is large and the output power of the permanent magnet rotor is stable after starting, it is designed with the relationship between the number of rotor poles Pᵣ and the number of stator teeth Pₛ in the permanent magnet control motor is Pᵣ=Pₛ−2 so as to reduce the alternating frequency of current.

The permanent magnet control motor stator 2 is double-layer winding, including an inner winding 211 and an outer winding 212. The coil selection of the inner winding and the outer winding adopts structures of four coils in series in one phase winding, which can be adjusted to whether the phase number is greater than 3 in the later control according to the connection relationship of the control circuit. The adjusted structure in the present invention is greater than 3 and is used as a motor. Considering the environmental requirements in engineering, sometimes it is needed to be used as a generator, the motor of the invention can also be used as a permanent magnet generator by reducing its phase number by one third through connecting in series the outer three sets of four coils, and the phase number in the adjustment period is less than 3. The preferred phase number of the stator winding is 6, which can be used as a 2-phase generator after adjusted.

The number of turns of the inner winding 211 is not the same as that of the outer winding 212 in the permanent magnet control motor to ensure that the static characteristic of each turn and the control system are suitable for control in power transformation. The magnetic permeability on direct axis is A_{d}, the magnetic permeability on quadrature axis is A_{q}, the magnetic flux φₘ of each coil is obtained by motor equation analysis, the number of turns of each coil is N_{coil}, the corresponding permanent magnet flux linkage and inductance meet:

Ψₘ=N_{coil}φₘ (formula 1)

L_{d}=A_{d}N²_{coil} (formula 2)

L_{q}=A_{q}N²_{coil} (formula 3)

Since the permanent magnet control motor adopts a fixed frequency, on the basis of the constant speed operation of the motor, the number of turns in the stator windings of the permanent magnet control motor is determined by setting the rated speed nᵣ, so as to achieve the requirements of the magnetic performance of the motor and the maximum current of the inverter during the control period. The specific control mode is explained by the circuit design of the controller.

In the temperature control, the invention adopts three-way water cooling control, a water cooling first channel 221, a water cooling second channel 222, and a water cooling third channel 223, so as to ensure that the temperature of the permanent magnet control motor is substantially constant in a small temperature difference change during operation, so that the magnetic flux can operate according to the designed magnetic path route. The water cooled first channel 221, the water cooled second channel 222, and the water cooled third channel 223 are arranged from the inside to the outside in order. The coils of the inner winding 211 and the outer winding 212 of the permanent magnet control motor are respectively arranged between the water cooled first channel 221 and the water cooled second channel 222, and the inner winding 211 and the outer winding 212 are separated by silicon steel plates.

Three separation copper sheets 2211 are placed in the water cooled first channel 221 for separating the water into four branches so as to prevent the vortex and leakage of magnetic flux in the water cooled first channel in the case of permanent magnet control motor electromagnetic coupling, reduce the stray loss. This way of setting the separation copper sheet can reduce significantly the torque ripple, the constant temperature makes the stability of the permanent magnet motor control electromagnetic torque, the average electromagnetic torque can achieve a maximum value, and thus the positioning torque pulse coefficient of the permanent magnet control motor can decrease obviously.

The water cooled second channel 222 is a water cooled channel placed on the left side, the right side and the bottom side. The outer winding 212 is surrounded by the three sides to avoid the coil insulation damage caused by the rapid rise of heat due to the large current during the motor starting and effectively prevent the stator winding loss. The water cooled second channel on the bottom is next closely to the outer winding 212, and the second channel 222 is made of flat, hollow, light weight aluminum or copper strips. In the manufacturing process of the water cooled second channel 222, the plug-in setting can better ensure that the magnetic path is carried out according to the setting mode so as to maintain the stability of motor rotation.

The shell 240 is a heat dissipation shell fixed tightly to the peripheral of the stator core 200, which is for fixing motor stator to prevent the damage caused by the motor vibration, impact, etc. In the motor, the shell 240 and the stator core 200 adopt a clamping structure with dovetail groove, the water cooled second channel 222 around the outer winding 212 on the left and right sides is surrounded by the stator core on its three sides, so as to ensure the stability in connection. The water cooled third channel 223 is provided in the shell 240 and is independently supplied cooling water, and its flow pressure and speed are obviously greater than that of the water cooled first channel 221 and the water cooled second channel 222, which is conducive to external heat dissipation and keeps the motor operating temperature constant, especially to prevent the impact of day and night temperature difference on the motor operation. Since the motor is used in the mining area, the impact of flying stone and other external forces often occurs, the outer surface of the motor shell 240 is provided with a groove for heat dissipation, and meanwhile, the groove can effectively absorb the energy generated by the motor after the impact, and place the deformation of the motor stator core with its deformation to effectively protect the motor. The part of the motor output shaft is installed with a special protective housing to prevent be damaged by external forces.

The flow speeds in the water cooled first channel 221, the water cooled second channel 222, and the water cooled third channel 223 of the motor are different, the flow speeds are roughly at the rate of increase in turn. For example, when selecting the flow speed in the water cooled third channel 223 is 1 m/s, the flow speed in the water cooled second channel 222 is 0.8 m/s, and the flow speed in the water cooled first channel 221 is 0.6 m/s, the said flow speeds are controlled by a temperature sensor and a motor central controller. In order to prevent the impact of the change of water supply pressure on the water supply channel, the invention adopts a relatively gradually changing water flow speed to adjust the motor stator temperature in the water supply regulation, only when the temperature from the motor sensor rises obviously and exceeds the set threshold, the variable water flow speed is used to supply water. A constant temperature water flow device is usually placed in the external water tank to ensure the water temperature.

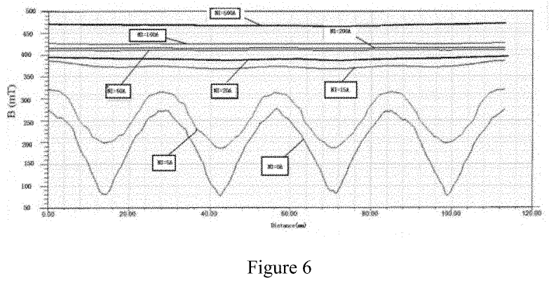

The variation and distribution of the magnetic field in the stator core are effectively calculated by the simulation of the magnetic field in the motor stator. The center of the stator is taken as the center point, and the values are set according to the same distance in turn to set different radius. The closer to the shell part, the smaller the induction intensity of the magnetic field is. FIG. 6 is a simulation diagram of magnetic induction intensity in the stator core of the permanent magnet control motor in the present invention. When the excitation winding is not energized, the magnetic field within the stator core 200 is only generated by the magnetomotive force FPM generated by the rotor permanent magnet. In the process that the excitation current I in the stator winding slowly increases from 0, the magnetic field intensity H within the stator core 200 will be generated by the joint action of permanent magnet magnetomotive force F_{PM} and axial magnetomotive force F_{Z}. When the excitation current keeps increasing, the axial magnetomotive force F_{Z} in the stator also keeps increasing, and the magnetic field in the stator core will gradually increase. When the magnetic field intensity H in the stator core tends to saturation until it reaches the maximum magnetic field intensity H_{Z}, the magnetic conductivity in the stator core 200 will continue to decrease, and the magnetic resistance of the stator core will continue to increase, so that the effective magnetic flux in the air gap between the stator and the rotor will decrease. In the simulation experiment, by adjusting the current I in the excitation coil, the magnetic field intensity B in the stator core and the axial magnetic field induction intensity B_{Z} in the stator core are observed. Setting that in the XY plane of the stator core can produce electromagnetic intensity expressed as H_{XY}, the axial magnetomotive force is F_{Z}, the stator magnetic reluctance is R_{M} and the rotor magnetic reluctance is R_{R}, setting the equivalent magnetic reluctance in radial air gap of the motor is R_{σ}, and the leakage magnetic reluctance of the core is R_{S}, and the axis excitation flux Φ_{S} in the axis excitation equivalent magnetic path of the permanent magnet control motor can be obtained by simulation according to the empirical formula,

Φ_{S}=F_{Z}*H_{XY}/(2R_{M}+R_{R})(2R_{σ}+R_{S})

The magnetic field intensity H generated in the stator core is proportional to the flux Φ_{S}. FIG. 6 simulates the magnetic field intensity of the stator core, it is substantially in accordance with the setting calculation formula in practice, in which the waveform of the magnetic field intensity B generated in the core also confirms the intensity changes in different distances. In this invention, by using a new rotor permanent magnet, especially in the simulation experiment in which the filling material 114 with smaller magnetism is between the first permanent magnet 111 and the third permanent magnet 113, according to the different rotor magnetic field, the magnetic field intensity within the stator core will change significantly because of different current values, with the continuous increase of excitation magnetomotive force, the waveform of magnetic field intensity B in the stator core becomes more and more flat, and the magnetomotive force reaches close to the saturated state of the stator core when the excitation magnetomotive force is in 60 A. With the gradual increase of the excitation current, the magnetic field intensity in the stator core 200 increases slowly, and the axial magnetic field intensity B_{Z} in the core increases slightly. Based on the simulation results, it is known the relationship between how much of the current increase and the produced heat during adjusting the motor output power in the present invention so that the different flow speeds of water in the water cooled first channel 221, the water cooled second channel 222 and the water cooled third channel 223 can be adjusted according to the cooling effect, the motor is in a state of constant temperature, and it can keep the accuracy of the motor control and a long service life.

The air gap magnetic field of the permanent magnet control motor is generated by the permanent magnet and therefore cannot be adjusted. This is also a common characteristics and disadvantage of permanent magnet motors. In the present invention, the permanent magnet of the permanent magnet control motor is always attached on the surface of the rotor and inside the rotor core, layered, naturally formed into a loop by the magnetic conductive bridge formed by core, axial length relatively long, the axial air gap magnetic density is negligible, so that the end effect produced by the corresponding stator winding is smaller, and the mutual effects may be negligible.

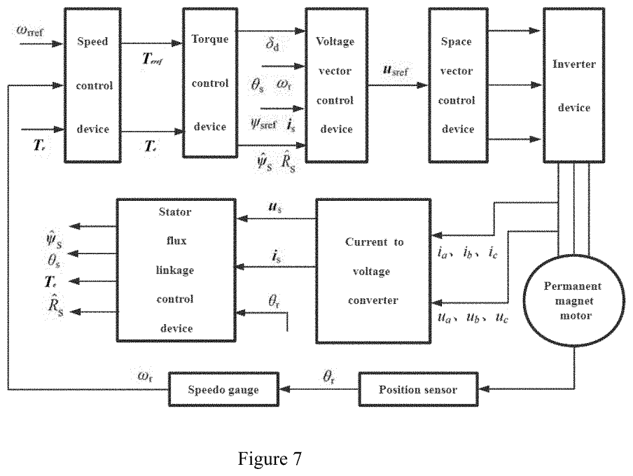

Aiming at the permanent magnet control motor and its cooling water channel, it is necessary to control the cooling water channel with reference to the change of water temperature in the motor control, so a specific control circuit is adopted. FIG. 7 shows the control diagram of the permanent magnet control motor, it is a closed loop control circuit connected to a speed control device, a torque control device, a voltage vector control device, a space vector control device and an inverter control device in sequence, in which the current/voltage conversion value deriving from the motor is provided to a stator flux linkage control device, the control signal produced by the stator flux linkage control device is delivered to the speed control device, the torque control device, and the voltage vector control device, and the signal obtained from the rotation angle detected by the position sensor of the permanent magnet control motor is transmitted to the speed control device to produce the angular velocity ωᵣ.

The inverter device in the present invention can better solve the appropriate number of vector to satisfy the control requirement, which is implemented by space vector control device. The space vector PWM technology is used, a long vector is obtained in d-q space, the utilization ratio of voltage is raised. Meanwhile, it ensures all the vector sum of voltage space vectors is zero, reduces the low harmonic components in PWM waveform. In the present invention, a control circuit with parallel topology structure is used to adapt to adverse factors such as large temperature difference and more dust in bad weather such as desert, so as to increase the reliability of the transmission system. In the traditional three-phase space vector control, the switch vector of the inverter is 100, and that of the other inverter is 101, the sector composed of 100 and 101 occupies one sixth of the entire control area in the entire control figure. When the longer space vector is selected in the present invention, the switching vector of the inverter is 110′, and that of the other inverter is 100′. The sector composed of 100′and 101′ occupies one twelfth of the entire control area in the entire control figure, and the resulting control mode is more accurate.

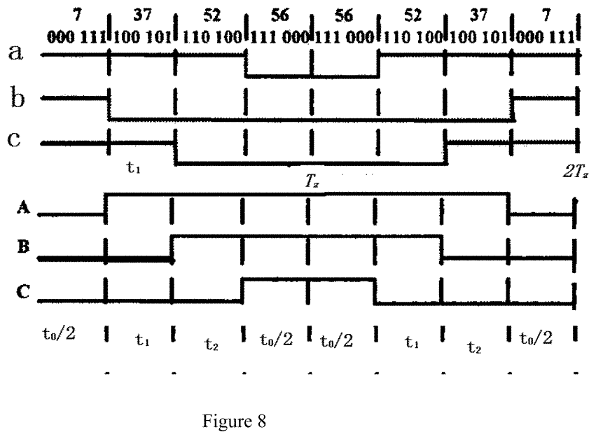

In the pulse width modulation signal formed by a sector of the parallel topology, it can be seen that the PWM waveform can be completely implemented by the non-null space vector, which can be controlled by inserting the zero vector into the non-null space vector. FIG. 8 shows the waveform of a pulse width modulation signal over during two cycles in one sector. In one sampling period of pulse width modulation, the two longest vector spaces of d-q space and the action time of the d-q space zero vector are included, and the corresponding waveform is obtained by space conversion. Wherein, a PI linear controller is included in the speed control device in FIG. 7, a control deviation is formed by comparing the given reference angular velocity ω_{rref} with the calculated angular velocity ωᵣ, and a torque control value is formed by a linear combination of the proportion and integral of the deviation so as to form an actual measurement value of torque. In the stator flux linkage control device, the detected values in the three-phase voltage input from the permanent magnet control motor are input an AD converter to obtain three phase currents iₐ, i_{b}, i_{c} and three-phase voltages uₐ, u_{b}, u_{c}, it includes two kinds of current and voltage transformation form in which CLARK transformation is used. It can deduce the relationship between amplitudes of i_{α} and i_{β} is of 1.5 by using A phase current i_{α}=iₐ−0.5i_{b}−0.5i_{c}, which shall be carried out under the same power, in the same way, the voltage before the transformation is U and the voltage effective value after the transformation is 1.5 times of U, namely 1.5 U, the power before the transformation is P=UI/3, while the power after the transformation is P=1.5*1.5*2*UI. In order to ensure the equal power, the square root of ⅔ is used as the coefficient in the calculation formula, which is also the established value adopted in the simulation.

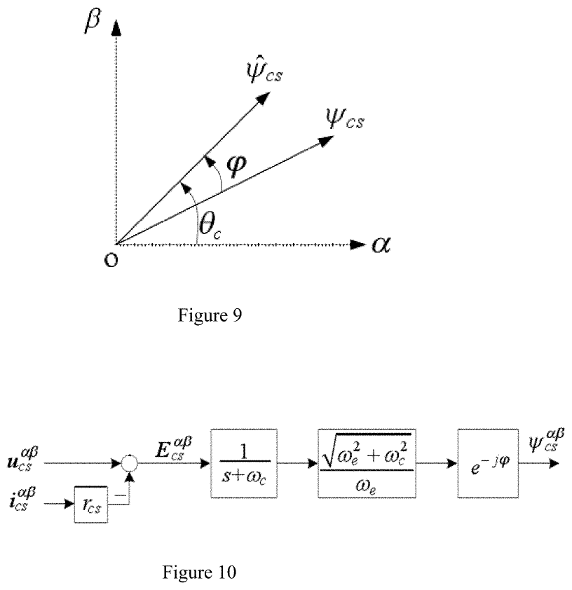

The transformed voltage and current value and the measured position angular are as the parameters of the stator flux linkage control device, and the control parameters \hat{R}_{S}, Tₑ, \acute{ω}ₛ, τ̅ₛ are output by the stator flux linkage control device. In the simulation, the speed is measured by a position sensor, the actual speed and the measured values are the same, and the change of the stator flux linkage is difficult to detect so that observation of the stator flux linkage is obtained according to the change of the resister resistances and the linear adjustment of the inductor parameters of linear adjustment during simulation. By the design of circuit, when inductor parameters do not change, there is no deviation in flux linkage, so the actual parameters determined by the stator flux linkage value are also determined under resistance change. In the specific circuit designed by the present invention, when the flux linkage fluctuates greatly, the rotation speed fluctuation can be recovered quickly by circuit control, in which the anti-disturbance control circuit designed is adopted. FIG. 9 shows the relationship between the estimate value the, and actual value Ψ_{c} in the stator flux linkage obtained by simulation. In the actual experiment, the included angle between the two is very small, about 0.5° to 3°, so that the permanent magnet control motor of the present invention has a very good controllability.

The present invention includes a magnetic path correction circuit in the stator magnetic path, the correction circuit consists of an integrator in series a low-pass filter, is of simple structure, and is only associated with the stator resistance of permanent magnet control motor. By the stator resistance value under the control of the water cooling system, it can better overcome the influence of the eddy current loss on the permanent magnet temperature, and ensure that the motor can operate within the permanent magnet temperature inflexion point and under the substantial constant temperature. According to the three water cooled system (the water cooled first channel 221, the water cooled second channel 222, and the water cooled third channel 223) of the present invention, the permanent magnet temperature change is small, and it can be controlled within 0.5 degree range. The corrective electric potential E_{cs}^{αβ} is obtained by the integral of the correct voltage u_{cs}^{αβ} and the correct current i_{cs}^{αβ}, the stator resistance is close to a fixed value, and the output corrected flux Ψ_{cs}^{αβ} is stable by means of low pass filter. By using a pure integrator, the dc drift such as the measurement error of voltage and current and the initial value error, and the integral saturation, are relatively small. The cut-off frequency of the low pass filter is used to replace the integral loop, which can better control the stator angular frequency of the permanent magnet control motor. FIG. 10 shows the calculation formula model diagram of the magnetic path correction circuit. It can be seen from the formula in the figure that since the closed loop control circuit is adopted in the present invention, the control accuracy and control mode can be better guaranteed by this setting in case of adding the magnetic path correction circuit.

One of the beneficial effects of this invention is that: depend on the specific structure of permanent magnet control motors in this invention, the magnetic path correction circuit is added in the control circuit to realize the accurate control, the cooling cycle ensures the evenness of the temperature inside the motor so that there will be no local high temperature regions to prevent motor in long term operation from failure due to local high temperature, so as to realize the long term high strength operation of permanent magnet control motors.

The disclosure in this present invention is not limited to the technical solution and any specific selection or combination of advantages and characteristics of the invention, etc., for a person skilled in the art, various combinations, variants and simple changes of the technical solution, advantages and characteristics described in the present invention can be thought to form the technical solution disclosed in the present invention.

1-10. (canceled)

11. A permanent magnet motor, including a stator and a rotor, wherein the said rotor is the permanent magnet formed in one piece, the said permanent magnet is layered and includes a first permanent magnet, a third permanent magnet and a filling material for increasing the higher harmonic magnetic field reluctance and harmonic leakage reactance, the coercive force of the third permanent magnet is greater than that of the first permanent magnet, the radial length ratio of the first and the third permanent magnet is 3:1, the radial length ratio of the said filling material and the said third permanent magnet is 1:9.

12. The permanent magnet motor according to claim 11, wherein the said permanent magnet is layered with rectangular blocks.

13. The permanent magnet motor according to claim 12, wherein the relationship between the number of rotor poles Pᵣ and the number of stator teeth Pₛ is Pᵣ=Pₛ−2.

14. The permanent magnet motor according to claim 13, wherein the stator has double-layer windings including an inner winding and an outer layer winding; coils of the said inner winding and the said outer winding have structures of four coils in series in one phase winding, and the phase number of the said stator winding is greater than 3.

15. The permanent magnet motor according to claim 14, wherein the magnet weight of the first permanent magnet is lighter than that of the third permanent magnet, the said first permanent magnet is sintered by a first alloy powder made by grinding alloy melted by a first component and a second alloy powder made by grinding alloy melted by a second component, the first and the second alloy powder are mixed with a weight percentage of 2:1; and the said third permanent magnet is sintered by the said first alloy powder made by grinding alloy melted by the said first component and the said second alloy powder made by grinding alloy melted by the said second component, the first and the second alloy powder are mixed with a weight percentage of 4:7.
